(19) United States
(12) Patent Application Publication
(10) Pub. No.: US 2008/0198992 A1
(43) Pub. Date: Aug. 21, 2008

(54) Method for Setting Up a Multimedia Connection In Case Of Cascade Connection Transfer

(75) Inventor: Klaus Hoffmann, Munchen (DE)

Correspondence Address: BELL, BOYD & LLOYD, LLP, P.O. BOX 1135, CHICAGO, IL, 60690, US

(73) Assignee: Nokia Siemens Network GmbH & Co. KG, Munchen (DE)

(21) Appl. No.: 11/994,988

(22) PCT Filed: Jun. 6, 2006
(86) PCT No.: PCT/EP2006/062922

§ 371 Date: Apr. 7, 2008

(30) Foreign Application Priority Data
Jul. 5, 2005 (DE) 10 2005 031 410.4

(51) Int. Cl. H04M 3/42

(52) U.S. Cl. 379/211.02

(57) ABSTRACT

The invention concerns a method for setting up a multimedia connection via a packet-switching computer network between at least one first calling subscriber (A-Tln) and at least one first called subscriber (B-Tln), the called subscriber terminal (B-Tln) triggering a cascade call transfer to other subscriber terminals (C-Tln, D-Tln). The invention is characterized in that the multimedia connection of the calling subscriber (A-Tln) to the terminal of the first called subscriber (B-Tln) is first set up via a network element (PR) of the computer network. Then, the terminal of the first called subscriber (B-Tln) transmits to the network element (PR) the connection transfer to another terminal (C-Tln, D-Tln) and the data associated with said other subscriber terminal (C-Tln, D-Tln). The network element (PR) then retransmits, while maintaining the multimedia connection to the calling subscriber (A-Tln), the setting up of the connection to said other subscriber terminal (C-Tln, D-Tln). The invention thus ensures in simple manner that a specific network element (PR) continues, notwithstanding the cascade call transfer, to participate in the setting up of the multimedia connection, thereby enabling the multimedia connection to be taxed, a legal interception to be performed and traffic measurements to be made.

The invention relates to a method for setting up a multimedia connection via a packet-oriented computer network, the multimedia connection being set up between at least one calling subscriber and at least one first called subscriber and the terminal of the called subscriber instigating a cascaded call forwarding to further subscriber terminals.

In recent years computer networks have developed into a significant communications medium via which a multiplicity of services are offered. Such computer networks comprise a quantity of so-called network elements—also referred to as network nodes—which are connected to one another by means of connections—also referred to as so-called edges. For access to the computer network or in order to be able to utilize the multiplicity of services, use is made of so-called terminals—such as, for example, PCs, modems or telephones—which are connected to the computer network via a network connection.

The best-known computer network throughout the world is the Internet, denoting the totality of all the networks that are connected to one another and utilize the Internet Protocol IP as transport protocol, data being transmitted in the form of packets by the Internet Protocol. Therefore, the Internet is also counted among the so-called packet-oriented computer networks.

Reliant on the Internet Protocol are transport protocols such as the Transmission Control Protocol TCP or the User Datagram Protocol UDP, and on these in turn a virtually impenetrable diversity of different application protocols, which in part compete with one another, such as e.g. http, FTP or for the management of multimedia connections the so-called Session Initiation Protocol, which is also referred to as SIP protocol for short, or the ITU-T standard H.323.

For multimedia connection two competing standards therefore currently exist for signaling: H.323 and SIP. The ITU-T standard H.323 (ITU; International Telecommunication Union) was developed for the real-time transmission of multimedia applications such as voice and video communication in packet-oriented networks. As a so-called umbrella standard it encompasses a series of protocols, for instance for signaling, exchange of terminal functionalities and status information and for connection and data flow control.

For the case of a multimedia connection in which the set-up of user information channel—also referred to as bearer or bearer channel—and signaling are effected separately, the ITU-T standard Q.1902.XBICC CS2 (bearer independent call control capability set 2) and Q.765.5 BAT (bearer application transport) in parallel and alternatively additionally defined how known additional services or service facilities such as call diversion or forwarding can be realized.

The Session Initiation Protocol SIP was developed by the IETF (Internet Engineering Task Force). The standard defines a signaling protocol for setting up, modifying and ending sessions with two or more subscribers. The SIP protocol likewise serves for transmitting real-time data via packet-oriented networks and is functionally comparable with the protocols in accordance with the ITU-T standard H.323. The Session Initiation Protocol SIP can communicate interactive communication services including voice via IP networks; in this case, the transport functions by means of TCP (Transmission Control Protocol) or UDP (User Datagram Protocol). In this case, the SIP protocol is for the call signaling and also the localization and registration of users. In particular, however, the communication of the caller's identity and call forwarding in IP networks are also made possible.

In contrast to the ITU-T standard H.323, the SIP protocol was developed having regard to the Internet and is therefore text-oriented, based on http (Hypertext Transfer Protocol) and thus offers an open Internet-based structure. For this reason, new service features can be implemented relatively simply and rapidly.

Both of the standards mentioned are constantly being developed further and basic first considerations are also being contemplated about a possible co-operation of different communication networks in which one standard or the other is used. Examples of this include, relatively recently, Q.1912.5 “Interworking SIP and BICC/ISUP” for the ITU-T and the Request for Comments RFC 3665 “SIP Basic call flow examples” and RFC 3666 “SIP PSTN Call flows”. Said RFCs will also contemplate first considerations with regard to the additional service facilities such as call diversion, call forwarding, etc. known from the Integrated Services Digital Network ISDN, denoting a digital circuit-switching network for the transmission of voice and data.

However, since the SIP protocol only serves to enable communication in a packet-oriented network, other protocols such as the Session Description Protocol SDP and the Realtime Transport Protocol RTP are used for the actual exchange of data. The SDP, which is described in the RFC 2327 of the IETF, negotiates e.g. the transport protocols to be used between the terminals of a connection. The task of the RTP, which is defined by the RFC 3550, is to packetize the multimedia data (e.g. audio, video, text, etc.) and send them by means of UDP, for example. Together with the SDP and RTP protocols, SIP can be used for so-called Internet telephony.

In contrast to conventional telephony, in Internet telephony voice information is not transmitted via a switched connection in the communication network, but rather is divided into data packets by protocols such as IP, TCP or UDP, for example. This transmission of the multimedia data (voice, audio, video, text, etc.) does not define the path from the terminal of the calling subscriber to the terminal of the called subscriber through the computer network.

From the standpoint of a network operator, however, it is important that at least one network element in a multimedia connection always participates in the path of the data transmission. For it is only in this way that it is possible to perform charging of the multimedia connection or lawful interception or traffic measurements in the multimedia connection. In computer networks or when the SIP protocol is used, such a network element which always participates in the path of the data transmission is referred to as a proxy. A proxy effects communication during the data transmission between the terminal of the calling subscriber and the terminal of the called subscriber.

If the case then occurs in a computer network—in particular in Internet telephony—that a multimedia connection to a called subscriber is set up by a first calling subscriber, the terminal of said called subscriber instigating a call forwarding to a further subscriber terminal, from which in turn a further call forwarding is possible, etc., then this is referred to as cascaded call forwarding.

For reasons of charging or lawful interception, however, it is necessary that in the case of cascaded call forwarding, too, at least one network element always participates in the set-up of the multimedia connection. Usually, for the case of call forwarding in computer networks, it is possible to use a so-called “recursive proxy”, which intercepts the call diversion to a further subscriber terminal.

In the case of cascaded call forwarding, however, this procedure has the disadvantage that in the proxy it is necessary to perform a plurality of redirections in the computer network in the direction of the terminal of the calling subscriber. Therefore, it is difficult—particularly in the case of interworking of different communication networks such as, for example, a computer network with SIP protocol and a so-called Public Switched Telephone Network PSTN or ISDN network and primarily at network gateways—to leave a proxy for charging and/or lawful interception in the multimedia connection.

In addition, the use of a so-called “recursive proxy”—primarily when using the SIP protocol—has the disadvantage that the SIP standard, which is defined in particular by the RFC 3261 of the IETF, does not permit a plurality of redirections in the SIP network in the direction of the terminal of the calling subscriber.

Therefore, the present invention is based on the object of specifying a method in which a specific network element always participates in the set-up of the multimedia connection and which also enables the use of the SIP protocol in the computer network.

This object is achieved according to the invention by means of a method for setting up a multimedia connection via a packet-oriented computer network between at least one calling subscriber and at least one first called subscriber, the terminal of the called subscriber instigating a cascaded call forwarding to further subscriber terminals. By means of this method, the first step involves starting the set-up of the multimedia connection from the calling subscriber to the terminal of the first called subscriber via a network element of the computer network. The terminal of the first called subscriber thereupon communicates to the network element the connection forwarding to a further subscriber terminal and the associated data of said further subscriber terminal, and then whilst maintaining the multimedia connection to the calling subscriber, the network element diverts the set-up of the multimedia connection to said further subscriber terminal.

The invention ensures in a simple manner that a specific network element, despite the cascaded call forwarding, always continues to participate in the set-up of the multimedia connection and the charging of the multimedia connection or lawful interception or traffic measurements can thus be carried out. By means of the network element, not only is the multimedia connection to the calling subscriber terminal set up, but the multimedia connection to the calling subscriber terminal is maintained, while the entire cascaded forwarding and thus the diversion of the multimedia connection to the further subscriber terminals is performed by the network element.

It is advantageous if the so-called Session Initiation Protocol SIP is used for the control and the management of the multimedia connection, since the SIP protocol is specified in the RFC 3261 of the IETF, in particular, and a standardized definition of a redirection of the bearer is made available by the RFC3311 “The Session Initiation Protocol (SIP) UPDATE Method”.

It is expedient if a so-called proxy is used as network element. Since a proxy is used for communication purposes during the data transmission between the terminal of the calling subscriber and the terminal of the called subscriber, it is possible in a simple manner for the proxy, in the case of cascaded call forwarding of a multimedia connection, always to continue to participate in the entire set-up of the connection.

One preferred configuration of the invention provides for the calling subscriber to be an SIP subscriber or to be a subscriber of the Public Switched Telephone Network (PSTN) which is connected to the computer network by means of SIP, whereby the SIP protocol standardized by the RFC 3261 and the UPDATE method described in the RFC 3311 can be used for the control and the management of the multimedia connection.

In one preferred exemplary embodiment, the first called subscriber is an SIP subscriber or a subscriber of the Public Switched Telephone Network (PSTN) which is connected to the computer network by means of SIP, whereby the SIP protocol standardized by the RFC 3261 and the UPDATE method described in the RFC 3311 can be used for the method according to the invention in a simple manner for the control and the management of the multimedia connection.

It is also expedient if the forwarding of the multimedia connection to an SIP subscriber terminal or to a PSTN subscriber terminal which is connected to the computer network by means of SIP is carried out, since the SIP protocol standardized by the RFC 3261, the UPDATE method described in the RFC 3311 and the standards which exist for the interworking of SIP networks and PSTN networks can thereby be used for the method according to the invention for the control and the management of the multimedia connection.

The invention is explained in more detail on the basis of an exemplary embodiment.

The exemplary embodiment relates to the case of a set-up of a multimedia connection by a calling subscriber A-Tln, which is either an SIP subscriber or a subscriber of the Public Switched Telephone Network (PSTN) which is connected to the computer network by means of SIP, to a first called subscriber B-Tln, which is likewise either an SIP subscriber or a subscriber of the Public Switched Telephone Network (PSTN) which is connected to the computer network by means of SIP.

Said first subscriber B-Tln has activated the service facility “call forwarding”, however, whereby the multimedia connection is diverted to a terminal C-Tln of a further SIP subscriber or PSTN subscriber connected to the computer network by means of SIP, which has in turn activated the service facility “call forwarding”, etc.

For the control and for the management of the set-up of the multimedia connection, the Session Initiation Protocol SIP or SIP-T is used as signaling protocol, as is described in the RFCs 3261 and 3311. For a description of the multimedia connection such as e.g. of the transport protocols to be used between the terminals, of the connection-specific data or of the data of the terminals, etc., the Session Description Protocol SDP, as defined in RFC 2327, is used.

As network element, a so-called proxy RP is used in the computer network.

According to the invention, then, a first step involves starting the set-up of the multimedia connection from the terminal of the calling subscriber A-Tln via the proxy PR to the terminal of the first called subscriber B-Tln. In a second step, the terminal of the first called subscriber B-Tln communicates to the proxy PR that the multimedia connection is to be forwarded to a further subscriber terminal C-Tln. In addition, the data of the further subscriber terminal C-Tln are communicated to the proxy PR. In a third step, the proxy PR on the one hand maintains the multimedia connection to the terminal of the calling subscriber A-Tln and diverts the set-up of the multimedia connection to the further subscriber terminal C-Tln.

If the service facility “call forwarding” was likewise activated at said subscriber terminal C-Tln, then the second and third steps of the method are carried out again, that is to say that the subscriber terminal C-Tln communicates to the proxy PR the forwarding of the multimedia connection to a further subscriber terminal D-Tln and the associated data and the proxy PR, whilst maintaining the multimedia connection to the calling subscriber A-Tln, thereupon diverts the set-up of the multimedia connection to said further subscriber terminal D-Tln. In this case, the proxy PR is always left in the connection set-up.

The proxy carries out the diversions of the connection set-up and processes responses of the further subscriber terminals C-Tln, D-Tln, etc., while the multimedia connection to the calling subscriber A-Tln is maintained by the proxy PR, in which case although the diversions or data regarding them are communicated to the terminal of the calling subscriber A-Tln, the transmissions UPDATE of said data are not managed by the proxy PR and the respective provisional responses of the terminal of the calling subscriber A-Tln thereto are not awaited by the proxy PR. It is only if the subscriber terminal C-Tln, D-Tln, etc. of the current diversion positively confirms the set-up of the multimedia connection that the provisional response of the terminal of the calling subscriber A-Tln to the transmission UPDATE that is presently current for the proxy PR is accepted and the multimedia connection is finally set up.

For further elucidation there is inserted below a table comprising an exemplary set-up of a multimedia connection in the case of cascaded call forwarding, which begins with the connection set-up from the terminal of the calling subscriber A-Tln to the terminal of the first called subscriber B-Tln via the proxy PR and then shows the data exchange and diversion of the multimedia connection by the proxy PR.

| | | | | | X-Tln, |
|---|---|---|---|---|---|
| A-Tln | Proxy PR | B-Tln | C-Tln | D-Tln | etc. |
| INVITE B | INVITE B | | | | |
| with SDP A → | with SDP A → | | | | |
| | | ← 100 | | | |
| | ← 18x with | ← 18x | | | |
| | SDP B | with SDP B | | | |
| | | ← 3xx | | | |
| | | call | | | |
| | | diversion | | | |
| | | to C | | | |
| | INVITE C | | | | |
| | with SDP A → | | | | |
| | | | ← 100 | | |
| | ← UPDATE | | ← 18x | | |
| | with SDP C | | with SDP C | | |
| | | | ← 3xx | | |
| | | | call | | |
| | | | diversion | | |
| | | | to D | | |
| | INVITE D | | | | |
| | with SDP A → | | | | |
| | | | | ← 100 | |
| | ← UPDATE | | | ← 18x | |
| | with SDP D | | | with SDP C | |
| | Without | | | | |
| | waiting for | | | | |
| | the 200 OK | | | | |
| | for the | | | | |
| | previous | | | | |
| | UPDATE | | | | |
| | | | | ← 3xx | |
| | | | | call | |
| | | | | diversion | |
| | | | | to X, etc. | |

Although it is apparent from the descriptions of the UPDATE method within the RFC 3311 that the case where a network element such as the proxy PR which has transmitted a transmission UPDATE transmits yet another transmission UPDATE before the first transmission UPDATE has been answered ought not actually to occur, since this case is likewise explicitly described for the receiving end in the RFC 3311, this is applied in order to relieve the proxy PR of the burden of the management of the many transmissions UPDATE. The transmissions UPDATE then need not be stored by the proxy and the respective responses thereto need not be awaited before the set-up of the multimedia connection is continued further.

Rather, the possible provisional responses of the terminal of the calling subscriber A-Tln to the transmissions UPDATE are always mapped directly without taking account of the respective history. Upon reception with respect to the transmissions UPDATE, the proxy PR then takes a decision in accordance with the table presented below:

| Response to UPDATE | Reaction of the proxy | |
|---|---|---|
| by the A-Tln | PR | |
| 500 with retry after | This response is | The retry after |
| header as response to | ignored since the | header specifies a |
| the UPDATE | second UPDATE is now | time interval after |
| transmitted first | the more up-to-date, | which the request is |
| | and is now important | to be transmitted |
| | and is processed | again in order that |
| | further | it can be processed. |
| | | This is already |
| | | defined in the RFC |
| | | 3261 - section 12.2.2 |
| | | for SIP. |
| 500 to the UPDATE | Owing to UDP | |
| transmitted first | (messages can | |
| (this on account of | overtake one | |
| the Cseq that is | another), the UPDATE | |
| lower than the Cseq | transmitted last has | |
| of the UPDATE | arrived at the | |
| transmitted last but | partner before the | |
| received first by | UPDATE transmitted | |
| means of UDP) | first. However, this | |
| | first UPDATE response | |
| | is no longer | |
| | important and is | |
| | therefore ignored. | |
| 200 OK to the first | Is ignored since the | |
| UPDATE | second UPDATE is | |
| 200 OK to the second | Is accepted | |
| UPDATE | | |

If no new provisional response has been received in the meantime from a new subscriber C-Tln, D-Tln, etc. to which diversion has been effected, the assessment—as in the table presented above—is not necessary since no transmission UPDATE has been retransmitted directly after the first transmission UPDATE.

In principle, the method according to the invention can also be transferred from the UPDATE method and applied to the INVITE method, that is to say for other cases of bearer diversion in order to enable the interworking for the proxy PR in those cases as well. In the method according to the invention, UPDATE is then replaced by INVITE in the corresponding tables and the responses associated with INVITE are then assessed correspondingly.

1. A method for setting up a multimedia connection via a packet-oriented computer network between at least one calling subscriber (A-Tln) and at least one first called subscriber (B-Tln), the terminal of the called subscriber (B-Tln) instigating a cascaded call forwarding to further subscriber terminals (C-Tln, D-Tln),
characterized in that
the first step involves starting the set-up of the multimedia connection from the calling subscriber (A-Tln) to the terminal of the first called subscriber (B-Tln) via a network element (PR) of the computer network,
in that the terminal of the first called subscriber (B-Tln) thereupon communicates to the network element (PR) the connection forwarding to a further subscriber terminal (C-Tln, D-Tln) and the associated data of said further subscriber terminal (C-Tln, D-Tln),
in that, whilst maintaining the multimedia connection to the calling subscriber (A-Tln), the network element (PR) diverts the set-up of the multimedia connection to said further subscriber terminal (C-Tln, D-Tln).

2. The method as claimed in claim 1, characterized in that the so-called Session Initiation Protocol (SIP) is used for the control and the management of the multimedia connection.

3. The method as claimed in one of claims 1 to 2, characterized in that a so-called proxy (PR) is used as network element.

4. The method as claimed in one of claims 1 to 3, characterized in that the calling subscriber (A-Tln) is an SIP subscriber or is a subscriber of the Public Switched Telephone Network (PSTN) which is connected to the computer network by means of SIP.

5. The method as claimed in one of claims 1 to 4, characterized in that the first called subscriber (B-Tln) is an SIP subscriber or is a subscriber of the Public Switched Telephone Network (PSTN) which is connected to the computer network by means of SIP.

6. The method as claimed in one of claims 1 to 5, characterized in that the forwarding of the multimedia connection to an SIP subscriber terminal or to a PSTN subscriber terminal which is connected to the computer network by means of SIP is carried out.
